(19) United States
(12) Patent Application Publication
(10) Pub. No.: US 2010/0269580 A1
(43) Pub. Date: Oct. 28, 2010

(54) MOORING FAILURE DETECTION

(75) Inventors: Martin John Moody, Dunfermline (GB); Andrew Fraser Sutherland, Dunfermline (GB); Grant Fraser, Dunfermline (GB)

Correspondence Address: OLIFF & BERRIDGE, PLC, P.O. BOX 320850, ALEXANDRIA, VA, 22320-4850, US

(73) Assignee: QINETIQ LIMITED, LONDON (GB)

(21) Appl. No.: 12/438,006

(22) PCT Filed: Sep. 6, 2007
(86) PCT No.: PCT/GB2007/003338

§ 371 Date: Feb. 19, 2009

(30) Foreign Application Priority Data
Sep. 8, 2006 (GB) 0617716.6

(51) Int. Cl. G01L 5/04

(52) U.S. Cl. 73/158

(57) ABSTRACT

A mooring failure detector, for attachment to a mooring chain or wire rope, includes a power source, which is activated by the rupture of a rupture element, caused by a change in depth and hence pressure of the device. Activation of the power QC source provides power to a transmitter to signal the failure, either by acoustic or radio frequency means. The device can operate on an inclined mooring such that failure above or below the point of attachment results in a failure signal being transmitted.

This invention relates to detection of changes in depth and particularly, but not exclusively, to the detection of failure in mooring lines.

Marine vessels and structures are typically moored using one or more mooring lines, usually chains. Evidently failure of such a mooring line can result in unwanted movement of such a vessel or structure, potentially causing considerable damage. If a plurality of mooring lines are used (oil exploration platforms may have ten or more mooring lines) breakage of one, or a small number of lines may go undetected, significantly compromising the stability or station keeping of such a vessel or structure. There is therefore a requirement to provide a surveillance or monitoring system for detecting the breakage of mooring lines.

In many marine applications, the environment in which such a system would be required to operate is very harsh, resulting in data links and power supplies being difficult to install and maintain, and expensive. Furthermore, such a system may remain dormant for many years, should require little or no maintenance, and be fully reliable when called into operation.

It is therefore an object of a first aspect of the present invention to provide a simple and reliable mooring failure detector.

According to a first aspect of the invention there is provided a mooring failure detector, comprising a power source, a rupture element adapted to rupture at a predetermined pressure, and a signal transmitter; wherein rupture of said rupture disk causes activation of said power source, enabling said transmitter to emit a signal.

In this way, there is advantageously provided an autonomous device that can be permanently attached to a catenary or other mooring or riser that will indicate loss of integrity or breakage of the mooring or riser when the part to which the device is attached sinks to the sea bed, or below a predetermined depth. Permanent monitoring of the integrity of moorings of floating offshore structures can be provided with minimal intervention or disruption to the moored vessel. Deployment of the device will typically be by remotely operated vehicle.

Because the battery is only activated on failure of the mooring (ie the device is passive and unpowered until the rupture element fails) the device requires minimal or no maintenance during normal passive surveillance, and avoids problems associated with conventional batteries with finite shelf lives.

In one embodiment the power source is a sea water battery. A sea water battery uses salt water as an electrolyte, and in such an embodiment, the device is activated by the ingress of sea water into a compartment housing the battery. The sea water battery is preferably a magnesium-silver chloride battery, providing high energy density and affording excellent electrode stability. Such batteries can advantageously be stored almost indefinitely in a wide variety of conditions without any appreciable deterioration of capacity or performance.

Preferably the transmitter is an acoustic transmitter, however a buoyant radio frequency transmitter may be employed in certain embodiments.

There is also provided a mooring failure detection system comprising one or more such detectors and a receiver adapted to receive said transmitted signal.

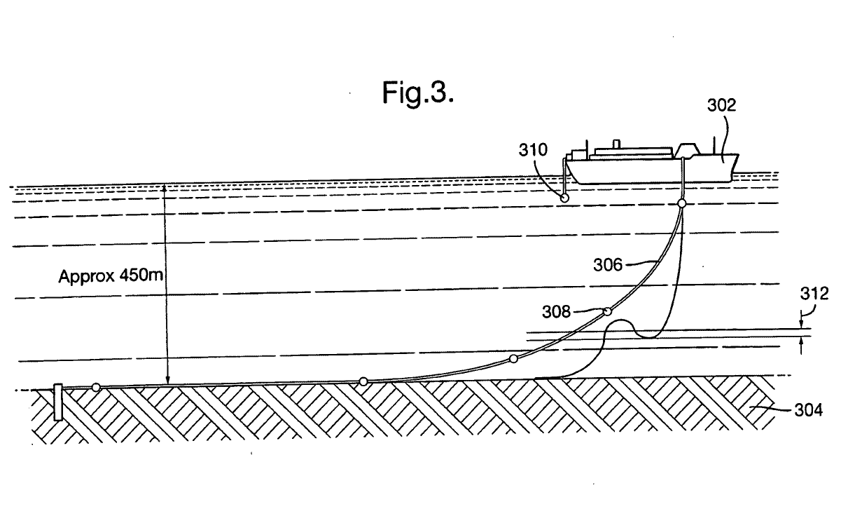

Embodiments of the present invention can advantageously be used in conjunction with inclined moorings such that a device can detect failure of the mooring above or below the point of attachment, as illustrated in FIGS. 3, 4 and 5 below. This aspect of the invention may be provided independently as a device for detecting failure of an inclined mooring, the device comprising an emitter and a depth sensor adapted to cause the emitter to emit a signal at a predetermined depth; wherein said device is mounted on said inclined mooring at a depth less than said predetermined depth and such that failure of the mooring above or below said device results in the device exceeding said predetermined depth.

Embodiments according to this aspect of the invention, may employ a pressure switch to activate an emitter powered by a conventional battery when the device exceeds a certain depth. Similarly, a simpler but less robust device is provided by replacing the rupture element of other aspects of the invention with a pressure switch, providing as a separate aspect of the invention a mooring failure detector including a signal transmitter and pressure switch, wherein activation of the pressure switch caused by a predetermined change in depth causes said transmitter to emit a signal. Embodiments of such a device are adapted to be secured in position on a mooring, and can be powered by a conventional battery.

A further aspect of the invention provides a device for detecting changes in depth, said device comprising a power source, a rupture element adapted to rupture at a predetermined depth, and a signal transmitter; wherein said device is unpowered until rupture of said rupture disk causes activation of said power source, enabling said transmitter to emit a signal.

The invention extends to methods and/or apparatus substantially as herein described with reference to the accompanying drawings.

Any feature in one aspect of the invention may be applied to other aspects of the invention, in any appropriate combination. In particular, method aspects may be applied to apparatus aspects, and vice versa.

Preferred features of the present invention will now be described, purely by way of example, and with reference to the accompanying drawings, in which:

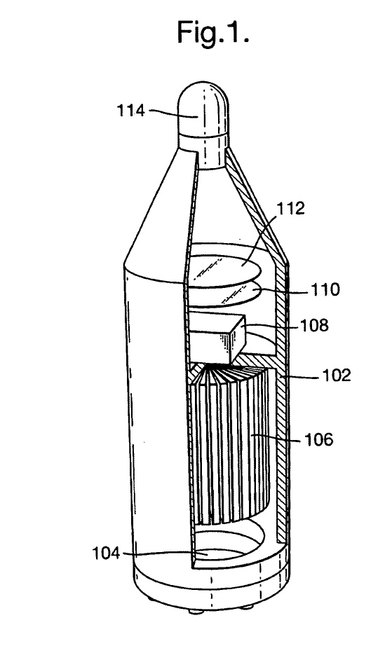

FIG. 1 is a cut away perspective view of an embodiment of the invention;

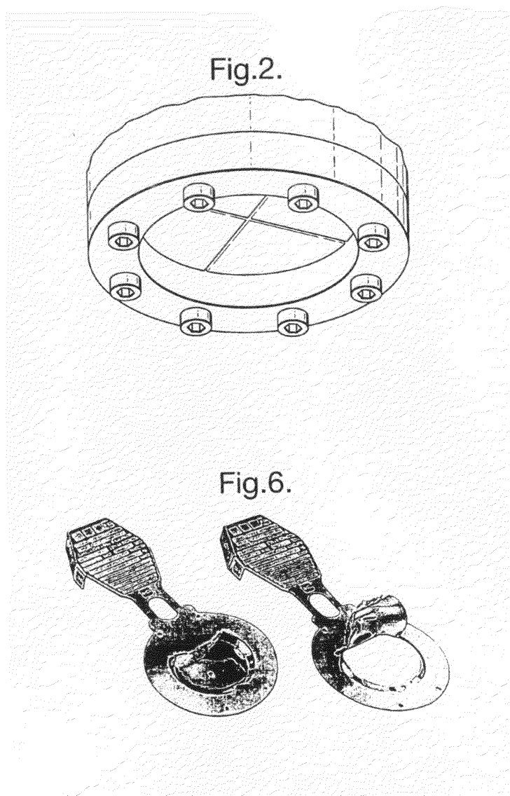

FIG. 2 shows a detail view of the arrangement of FIG. 1;

FIG. 3 shows a general mooring arrangement incorporating an embodiment of the present invention;

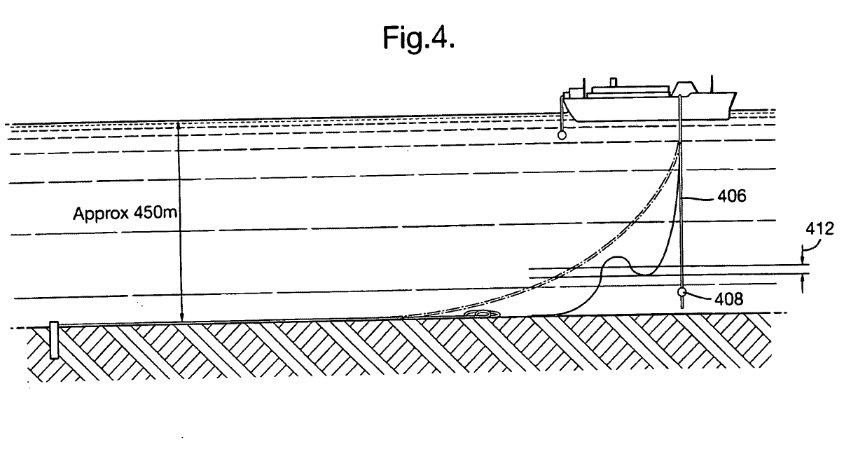

FIG. 4 shows a possible failure condition of the arrangement of FIG. 2;

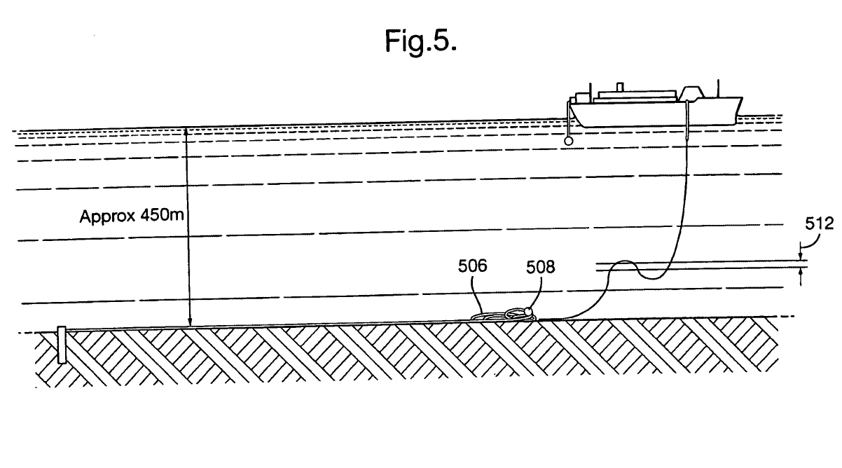

FIG. 5 shows an alternative failure condition of the arrangement of FIG. 2;

FIG. 6 shows a commercially available rupture disk.

Referring to FIG. 1, the device has an outer housing, or bulkhead 102. A rupture disk 104 (shown in greater detail in FIG. 2) seals the base of the bulkhead. A sea water battery 106 is located in a compartment behind the rupture disk.

A DC-DC power supply 108 is located in an upper compartment of the device, and is connected to the seawater battery. Also located in the upper compartment are a signal generator and encoder 110, and a power amplifier 112. The output of the amplifier is connected to an acoustic transmitter 114 mounted at the top of the device.

In operation, the device is attached to a mooring line at a certain depth. At this depth, the rupture disk can withstand the static pressure, and remains intact, keeping the seawater battery dry. Because the battery is kept inert in this steady state, the device has a very long service life.

When the pressure acting on the rupture disk exceeds a predetermined threshold, for example if its depth is sufficiently increased, the disk fails and allows sea water into the chamber housing the battery. This activates the battery and provides power, to the acoustic transponder that emits a predetermined acoustic signal. The signal generator, encoder and amplifier are also powered by the sea water activated battery combined with a suitable power supply/regulator circuit.

The predetermined acoustic signal is detected by a hydrophone attached to the moored vessel or other suitable control location, to indicate that the mooring has failed. In a system where there are a plurality of moorings, the signal can be encoded to identify the particular device from which it was transmitted, and therefore to identify which mooring has failed. By attaching a number of devices at different lengths along a single mooring, an indication of the position of the break can also be identified.

In an alternative embodiment, rupture of the disk and activation of the battery can trigger the release of a buoyant radio frequency transmitter, which floats to the surface and emits an encoded RF signal in an analogous fashion. In such an embodiment, the signal would be detected by a suitable antenna.

In FIG. 3, a marine structure 302 is tethered to the sea bed 304, by mooring 306, which may be a studless chain or wire rope, or a combination of wires and ropes for example. The mooring hangs in a catenary. A mooring failure device 308 according to an embodiment of the present invention is attached to mooring 306, and an appropriate acoustic receiver system, or hydrophone 310 is provided on the structure as shown.

The pressure failure range of the rupture disk corresponds to the depth range indicated at 312, sufficiently below the point of attachment of the device to prevent rupture during normal movement of the mooring.

FIG. 4 illustrates the situation when the mooring suffers a breakage below the location of the device. The loss of tension causes the remaining part of the mooring 406 attached to the structure (to which the device is attached) to hang freely, having the effect of lowering the device 408 past the rupture depth range 412, resulting in rupture of the disk and activation of the device. In FIG. 4 the depth of water is approximately 450 m resulting in a pressure range of approximately 45 bar from the surface to the sea bed.

FIG. 5 illustrates an alternative situation when the mooring suffers a breakage above the location of the device. Here, the remaining part of the mooring 506 to which the device 508 is attached simply falls to the sea bed, again lowering the device past rupture depth range 512, and causing activation of the device.

A commercially available rupture disk or diaphragm is shown in FIG. 6, both intact and in a ruptured condition. Rupture disks can be made in a wide range of materials and exhibit a wide range of failure pressures. Typical burst tolerance is within +/−5% of the rated pressure. Alternatively, a purpose made rupture element having any suitable geometry could be employed.

It will be understood that the present invention has been described above purely by way of example, and modification of detail can be made within the scope of the invention. Each feature disclosed in the description, and (where appropriate) the claims and drawings may be provided independently or in any appropriate combination.

1. A mooring failure detector, comprising a power source, a rupture element adapted to rupture at a predetermined pressure, and a signal transmitter;
wherein rupture of said rupture element causes activation of said power source, enabling said transmitter to emit a signal.

2. A detector according to claim 1, wherein said power source is a sea water battery.

3. A detector according to claim 1, wherein said transmitter is an acoustic transmitter.

4. A detector according to claim 1, wherein said transmitter comprises a buoyant radio frequency transmitter.

5. A detector according to claim 1, wherein said signal is encoded to identify the detector.

6. A detector according to claim 1, wherein said rupture element is a rupture disk.

7. A mooring failure detection system comprising one or more detectors according to claim 1, and a receiver adapted to receive said transmitted signal.

8. A system according to claim 7, wherein said transmitter is an acoustic detector and wherein said receiver comprises a hydrophone unit.

9. A system according to claim 7, wherein said transmitter comprises a buoyant radio frequency transmitter and wherein said receiver comprises an antenna.

10. A device for detecting failure of an inclined mooring, the device comprising an emitter and a depth sensor adapted to cause the emitter to emit a signal at a predetermined depth;
wherein said device is mounted on said inclined mooring at a depth less than said predetermined depth and such that failure of the mooring above or below said device results in the device exceeding said predetermined depth.

11. A device for detecting changes in depth, said device comprising a power source, a rupture element adapted to rupture at a predetermined depth, and a signal transmitter;
wherein said device is unpowered until rupture of said rupture element causes activation of said power source, enabling said transmitter to emit a signal.
